(19) United States
(12) Patent Application Publication
(10) Pub. No.: US 2024/0106045 A1
(43) Pub. Date: Mar. 28, 2024

(54) LEAD MEMBER

(71) Applicant: SUMITOMO ELECTRIC INDUSTRIES, LTD., Osaka (JP)

(72) Inventors: Akira TSUCHIKO, Tochigi (JP); Kengo GOTO, Osaka (JP); Kazuhiro GOTO, Osaka (JP); Koji KASUYA, Osaka (JP); Yoshihiro TSUKUDA, Osaka (JP); Yusuke KUREISHI, Osaka (JP)

(21) Appl. No.: 18/263,588

(22) PCT Filed: Feb. 12, 2021
(86) PCT No.: PCT/JP2021/005339

§ 371 Date: Jul. 31, 2023

(51) Int. Cl. H01M 50/198; H01M 50/172; H01M 50/193; H01M 50/197; H01M 50/562

(52) U.S. Cl. CPC H01M 50/198; H01M 50/172; H01M 50/193; H01M 50/197; H01M 50/562

(57) ABSTRACT

A lead member includes a lead conductor having a first main surface and a second main surface opposite to the first main surface. The lead member includes a resin portion that covers the first main surface, the second main surface, and two side surfaces that are between both ends of the lead conductor, while exposing the both ends of the lead conductor in a first direction. The lead conductor includes a metal substrate and a surface treatment layer formed on at least a portion of a surface of the metal substrate, the surface treatment layer including chromium, oxygen, and fluorine. A moisture content of a portion of the surface treatment layer exposed from the resin portion, as measured by coulometric Karl Fischer titration at a vaporization temperature of 220° C., is 5.0 μg/cm² or less.

### TECHNICAL FIELD

The present disclosure relates to a lead member.

### BACKGROUND ART

Non-aqueous electrolyte batteries such as lithium ion batteries have structures in each of which a positive electrode, a negative electrode, and an electrolytic solution are accommodated in an enclosure comprised of a laminated film. In the structures, lead members (tab leads) coupled to the positive electrode and the negative electrode are hermetically sealed, and are taken out to the outside. Each of the lead members is formed by welding a sealant film having a multilayer structure that is made of a resin film such as polypropylene (PP), onto a given region of both surfaces of the lead conductor, with the exception of both ends in a longitudinal direction of the lead conductor that is among an aluminum lead conductor for a positive electrode and, a nickel or nickel-plated copper lead conductor for a negative electrode. A surface treatment layer is formed on the surface of the lead conductor.

### RELATED-ART DOCUMENTS

### Patent Document

[Patent Document 1] Japanese Unexamined Patent Application Publication No. 2006-328501
[Patent Document 2] Japanese Unexamined Patent Application Publication No. 2012-48852

### SUMMARY OF THE INVENTION

A lead member in the present disclosure includes a lead conductor having a first main surface and a second main surface opposite to the first main surface. The lead member includes a resin portion that covers the first main surface, the second main surface, and two side surfaces that are between both ends of the lead conductor, while exposing the both ends of the lead conductor in a first direction. The lead conductor includes a metal substrate and a surface treatment layer formed on at least a portion of a surface of the metal substrate, the surface treatment layer including chromium, oxygen, and fluorine. A moisture content of a portion of the surface treatment layer exposed from the resin portion, as measured by coulometric Karl Fischer titration at a vaporization temperature of 220° C., is 5.0 μg/cm² or less.

### BRIEF DESCRIPTION OF DRAWINGS

FIG. 1 is a plan view of a lead member according to a first embodiment.

FIG. 2 is a cross-sectional view (part 1) of the lead member according to the first embodiment.

FIG. 3 is a cross-sectional view (part 2) of the lead member according to the first embodiment.

FIG. 4 is a plan view (part 1) illustrated for a method for manufacturing the lead member according to the first embodiment.

FIG. 5 is a plan view (part 2) illustrated for the method for manufacturing the lead member according to the first embodiment.

FIG. 6 is a plan view (part 3) illustrated for the method for manufacturing the lead member according to the first embodiment.

FIG. 7 is a plan view (part 4) illustrated for the method for manufacturing the lead member according to the first embodiment.

FIG. 8 is a diagram illustrating an example of a reflection infrared spectrum.

FIG. 9 is a diagram illustrating an example of an X-ray absorption spectrum.

FIG. 10 is an enlarged view of a portion in FIG. 9.

FIG. 11 is a schematic diagram illustrating an enclosure-type non-aqueous electrolyte battery.

FIG. 12 is a cross-sectional view of a battery module including a plurality of non-aqueous electrolyte batteries.

### MODE FOR CARRYING OUT THE INVENTION

### Problem to be Solved by the Present Disclosure

For conventional lead members, when a plurality of lead members are overlapped and welded, there are cases where weldability is not sufficiently provided.

### Effects of the Present Disclosure

According to the present disclosure, excellent weldability is provided.

One or more embodiments are described below.

### Description of Embodiments of the Present Disclosure

First, the embodiments of the present disclosure will be listed and described as follows. In the following description, the same or corresponding elements are denoted by the same signs, and description for these elements is not provided repeatedly.
[1] A lead member in one aspect of the present disclosure includes a lead conductor having a first main surface and a second main surface opposite to the first main surface. The lead member includes a resin portion that covers the first main surface, the second main surface, and two side surfaces that are between both ends of the lead conductor, while exposing the both ends of the lead conductor in a first direction. The lead conductor includes a metal substrate and a surface treatment layer formed on at least a portion of a surface of the metal substrate, the surface treatment layer including chromium, oxygen, and fluorine. A moisture content of a portion of the surface treatment layer exposed from the resin portion, as measured by coulometric Karl Fischer titration at a vaporization temperature of 220° C., is 5.0 μg/cm² or less.

The inventors of this application have conducted careful consideration to investigate the cause of insufficient weldability in conventional lead members. As a result, it has been found that a surface treating liquid is not sufficiently dried during formation of a surface treatment layer. Also, it has been found that, when the surface treating liquid is insufficiently dried, in a case where the moisture content of the surface treatment layer is greater than 5.0 μg/cm², weldability is reduced. The surface treating liquid that contains a trivalent chromium may be used to form the surface treatment layer. In this case, chromium is contained in the surface treating liquid in a state in which hydration water is bonded to ions of the trivalent chromium, and if drying is insufficient, excessive moisture may remain in the surface treatment layer. For a lead member in one aspect of the present disclosure, the moisture content of a portion of the surface treatment layer that is exposed from a resin portion, as measured by coulometric Karl Fischer titration at a vaporization temperature of 220° C., is 5.0 μg/cm² or less. With this arrangement, the moisture contained in the surface treatment layer is sufficiently low, thereby providing excellent weldability.
[2] A lead member in another aspect of the present disclosure includes a lead conductor having a first main surface and a second main surface opposite to the first main surface. The lead member includes a resin portion that covers the first main surface, the second main surface, and two side surfaces, between both ends of the lead conductor, while exposing the both ends of the lead conductor in a first direction. The lead conductor includes a metal substrate and a surface treatment layer formed on at least a portion of a surface of the metal substrate, the surface treatment layer including chromium, oxygen, and fluorine. For a portion of the surface treatment layer exposed from the resin portion, a value of a parameter that is obtained by dividing, by a chromium content (μg/cm²) per unit area, an integrated value of peak intensity in a wave number range of greater than or equal to 2750 cm⁻¹ and less than or equal to 3700 cm⁻¹ in a reflection infrared spectrum is 10.0 or less.

When a surface treatment layer is formed using a trivalent chromium-containing surface treating liquid, a peak that is derived from a Cr—OH bond appears in a wave number range of greater than or equal to 2750 cm⁻¹ and less than or equal to 3700 cm⁻¹ in a reflection infrared spectrum. That is, it means that an increased number of hydroxyl groups are present in a surface layer portion of the surface treatment layer in accordance with an increasing value of the parameter described above. When the hydroxyl groups are present excessively, drying is insufficient, and thus excessive moisture may remain in the surface treatment layer. For a lead member in another aspect of the present disclosure, the value of the parameter is 10.0 or less, and thus the number of hydroxyl groups contained in the surface treatment layer is sufficiently small, thereby providing excellent weldability.
[3] A lead member in yet another aspect of the present disclosure includes a lead conductor having a first main surface and a second main surface opposite to the first main surface. The lead member includes a resin portion that covers the first main surface, the second main surface, and two side surfaces, between both ends of the lead conductor, while exposing the both ends of the lead conductor in a first direction. The lead conductor includes a metal substrate and a surface treatment layer formed on at least a portion of a surface of the metal substrate, the surface treatment layer including chromium, oxygen, and fluorine. In an X-ray absorption spectrum for a portion of the surface treatment layer exposed from the resin portion, when one division on a horizontal axis indicates X-ray energy of 1 eV, and one division on a vertical axis indicates X-ray absorption of 0.1, a magnitude of an angle BAC is 17 degrees or less, where, for the X-ray absorption spectrum, a point A is a point at which the X-ray energy is 6008 eV, a point B is a point at which the X-ray energy is 6011 eV, and a point C is a point at which the X-ray energy is 6016 eV. A length of the one division on the horizontal axis is equal to a length of the one division on the vertical axis.

Coordination environments of oxygen and fluorine with respect to chromium are reflected on an X-ray absorption spectrum, which means that a coupling between atoms in a surface treatment layer is weak in accordance with an increase in the angle BAC described above. If the coupling is excessively weak, sufficient corrosion resistance is not provided. For a lead member in yet another aspect of the present disclosure, the magnitude of the angle BAC is 17 degrees or less, and the coupling between atoms is matched, thereby providing excellent corrosion resistance.
[4] In [1] to [3], a surface treatment layer may be an inorganic layer. In this case, excellent heat resistance is provided.
[5] In [1] to [4], a surface treatment layer may not be free of C. In this case, excellent heat resistance is provided.
[6] In [1] to [5], a surface treatment layer may be provided at least between a metal substrate and a resin portion. In this case, when a lead member is used for a non-aqueous electrolyte battery, leakage of an electrolytic solution is easily reduced.
[7] In [1] to [6], a surface treatment layer may be provided on an entirety of a first main surface and a second main surface. In this case, excellent corrosion resistance is easily provided over the entire lead conductor.
[8] In [1] to [7], a metal substrate may be formed of aluminum, an aluminum alloy, nickel, a nickel alloy, copper, a copper alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy. In this case, good conductivity is easily provided.
[9] In [1] to [8], a resin portion may include polypropylene. In this case, the resin portion is easily heat-sealed to a lead conductor.

### Details of Embodiments of the Present Disclosure

Hereinafter, one or more embodiments of the present disclosure will be described in detail, but the embodiments are not intended to be limiting. In the specification and the drawings, constituent elements having substantially the same functional configuration are denoted by the same signs, and description thereof may be omitted. In each drawing, an XYZ orthogonal coordinate system is set for convenience of description.

### First Embodiment

A first embodiment will be described as follows. The first embodiment relates to a lead member. The lead member can be used as a tab lead of a non-aqueous electrolyte battery such as a lithium ion battery.

### [Structure of Lead Member]

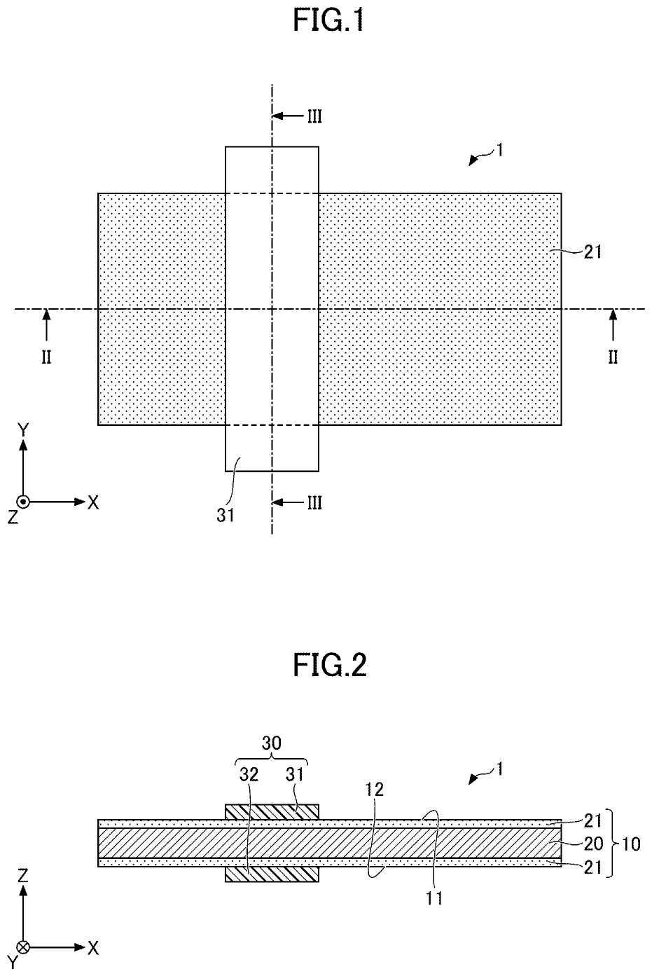

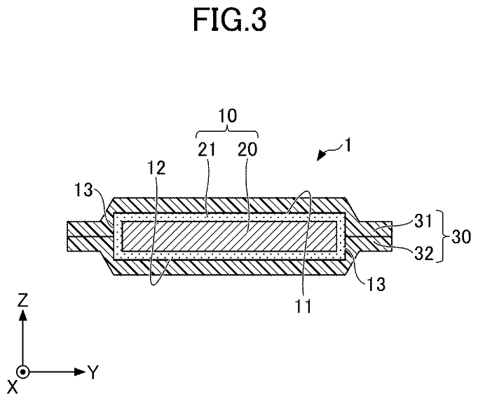

First, a structure of the lead member will be described as follows. FIG. 1 is a plan view of the lead member according to the first embodiment. FIGS. 2 and 3 are cross-sectional views of the lead member according to the first embodiment. FIG. 2 corresponds to a cross-sectional view taken along line II-II in FIG. 1. FIG. 3 corresponds to a cross-sectional view taken along line III-III in FIG. 1.

As illustrated in FIGS. 1 to 3, a lead member 1 according to the first embodiment includes a lead conductor 10 and a resin portion 30. The lead conductor 10 has a first main surface 11, a second main surface 12 opposite the first main surface 11, and two side surfaces 13 that connect the first main surface 11 and the second main surface 12. The lead conductor 10 includes a metal substrate 20 and a surface treatment layer 21.

The lead conductor 10 has, for example, a rectangular planar shape. In the present embodiment, in the planar shape of the lead conductor 10, a direction in which sides, for making a pair, parallel to each other extend corresponds to an X-direction, a direction in which sides, for making the other pair, parallel to each other extend corresponds to a Y-direction, and a direction normal to the first main surface 11 corresponds to a Z-direction. The dimension in the X-direction may be greater or smaller than the dimension in the Y-direction, or may be equal to the dimension in the Y-direction. For example, the two side surfaces 13 are perpendicular to the Y-direction. The X-direction is an example of a first direction.

The lead conductor 10 has a belt-like shape, and dimensions of the lead conductor 10 are appropriately set as necessary. For example, for the lead conductors 10, the thickness is greater than or equal to 0. 05 mm and less than or equal to 5. 0 mm, the length in the X-direction is greater than or equal to 1 mm and less than or equal to 100 mm, and the length in the Y-direction is greater than or equal to 10 mm and less than or equal to 200 mm.

The metal substrate 20 is formed, for example, of aluminum (Al), an aluminum alloy, nickel (Ni), a nickel alloy, copper (Cu), a copper alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy, or the like. By using these metal materials, the lead conductor 10 easily allows for good conductivity.

For example, the surface treatment layer 21 covers the entire surface of the metal substrate 20 on the first main surface 11-side, the entire surface of the metal substrate 20 on the second main surface 12-side, the entire surface of the metal substrate 20 on one side surface 13-side, and the entire surface of the metal substrate 20 on the other side surface 13-side. The surface treatment layer 21 contains chromium (Cr), oxygen (O), and fluorine (F). The surface treatment layer 21 is preferably composed of Cr, O, and F, but may contain inevitable impurities such as silicon (Si). For example, the surface treatment layer 21 is an inorganic layer, and preferably does not contain carbon (C). From the viewpoint of a load with respect to environment, Cr is preferably trivalent Cr.

In the first embodiment, the moisture content of a portion of the surface treatment layer 21 that is exposed from the resin portion 30, as measured by coulometric Karl Fischer titration at a vaporization temperature of 220° C., is 5.0 μg/cm² or less, preferably 3.0 μg/cm² or less, more preferably 2.0 μg/cm² or less. When the moisture content of the portion of the surface treatment layer 21 exposed from the resin portion 30 exceeds 5.0 μg/cm², weldability is not sufficiently provided. For example, when a plurality of lead members 1 are stacked, and portions of the lead conductors 10 that are each exposed from the resin portion 30 are welded to each other, misalignment between the lead members 1 may occur.

Now, the coulometric Karl Fischer titration in the present disclosure will be described as follows.

First, preheating is performed for 10 minutes using a moisture vaporizer. As the moisture vaporizer, for example, VA-230 manufactured by Nittoseiko Analytech Co., Ltd. can be used. Next, a lead member is set in the moisture vaporizer. Then, the lead member is heated to 220° C. to vaporize moisture contained in a surface treatment layer, and the vaporized moisture is measured using a coulometric Karl Fischer titration-type moisture instrument. As the coulometric Karl Fischer titration-type moisture instrument, for example, CA-200 manufactured by Nittoseiko Analytech Co., Ltd. can be used.

The moisture measurement is performed with a blank before and after measuring the moisture of a sample, and an average of measurements is calculated. Then, a moisture content A is determined by Equation 1 below. In Equation 1, A1 is a titration amount (μm) for the sample, A0 is an average of titration amounts obtained with the blank, and S is a total area (cm²) of portions of a given surface treatment layer that are exposed from the resin portion of the given surface treatment layer in the sample. A value obtained by Equation 1 is rounded off to two decimal places, for example.

(Math. 1)

A=(A1−A0)/S (Equation 1).

While exposing both ends of the lead conductor 10 in the X-direction, the resin portion 30 covers the first main surface 11, the second main surface 12, and two side surfaces 13 between the both ends. The resin portion 30 is disposed so as to cover an outer peripheral side of a partial region in the X-direction, with the exception of a region that includes the both ends of the lead conductor 10 in the X-direction. With this arrangement, the surface treatment layer 21 is provided at least between the metal substrate 20 and the resin portion 30. The both ends of the lead conductor 10 in the X-direction are electrically coupled to respective conductive portions such as electrodes or terminals, and thus are held in a state where the both ends are exposed without providing the resin portion 30. The resin portion 30 includes, for example, resin films 31 and 32 bonded to each other such that the lead conductor 10 is interposed between the resin films 31 and 32. The dimension of each of the resin films 31 and 32 in the Y-direction is greater than the dimension of the lead conductor 10 in the Y-direction, thereby enhancing sealing performance. For example, the thickness of each of the resin films 31 and 32 is greater than or equal to 30 μm and less than or equal to 500 μm, the length of each of the resin films 31 and 32 in the X-direction is greater than or equal to 2 mm and less than or equal to 50 mm, and the length of each of the resin films 31 and 32 in the Y-direction is greater than or equal to 3 mm and less than or equal to 250 mm. The resin film 31 is provided on the first main surface 11, and the resin film 32 is provided on the second main surface 12.

Each of the resin films 31 and 32 is, for example, a molded plastic body that is formed of a resin composition that contains polypropylene(PP). Although a method of manufacturing the lead member 1 is described below, the resin portion 30 is easily heat-sealed to the lead conductor 10, because the resin portion 30 contains polypropylene. The form of the molded plastic body is not necessarily a film form. For example, the molded plastic body may be a seamless resin that is formed by applying or extruding a resin composition onto the periphery of the lead conductor 10. In a case where any film is used, a single film can be wound around the lead conductor 10 to form the resin portion 30.

As illustrated in FIGS. 2 and 3, each of the resin films 31 and 32 has a single-layer structure. However, a laminate including a plurality of resin films may be used instead of the resin films 31 and 32 each of which has the single layer. For example, as each of the resin films 31 and 32, a two-layer structure can be used, and in the two-layer structure, a first layer made of a polyolefin resin, such as maleic anhydride-modified low-density polyethylene (PE) or polypropylene (PP), and a second layer made of a polyolefin resin, such as low-density polyethylene, are bonded to each other.

In the lead member 1 according to the first embodiment, the surface treatment layer 21 contains F, and thus the lead member 1 has good corrosion resistance to a non-aqueous electrolyte solution, particularly the non-aqueous electrolyte solution that contains a hydrofluoric acid. The moisture content of the portion of the surface treatment layer 21 exposed from the resin portion 30, as measured by coulometric Karl Fischer titration at a vaporization temperature of 220° C., is 5.0 μg/cm² or less. With this arrangement, excellent weldability is provided. Also, because the moisture content is low, and an amount of hydrate contained in the surface treatment layer 21 is small, the reaction between the surface treatment layer 21 and the non-aqueous electrolytic solution is reduced, thereby maintaining favorable battery performance easily.

In addition, the surface treatment layer 21 is an inorganic layer, and does not contain C. With this arrangement, excellent heat resistance is provided. For example, as compared with the surface treatment layer using an organic resin, excellent heat resistance is provided.

The surface treatment layer 21 is provided between the metal substrate 20 and the resin portion 30. With this arrangement, the electrolytic solution is unlikely to penetrate between the metal substrate 20 and the resin portion 30 in a case where the surface treatment layer 21 is used for a non-aqueous electrolyte battery. Thus, leakage of the electrolytic solution is more likely to be reduced.

The surface treatment layer 21 does not need to be entirely provided on the first main surface 11 and the second main surface 12. However, when the surface treatment layer 21 is entirely provided on the first main surface 11 and the second main surface 12, excellent corrosion resistance is more easily provided over a wide range of the lead conductor 10.

### [Method for Manufacturing Lead Member]

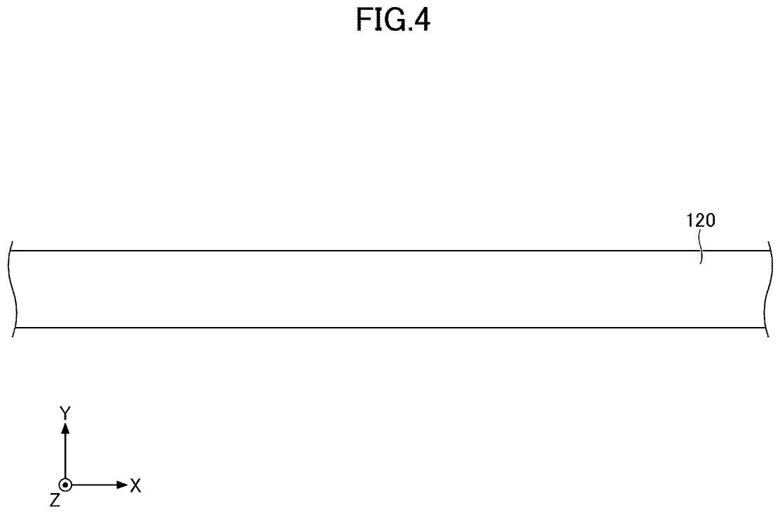

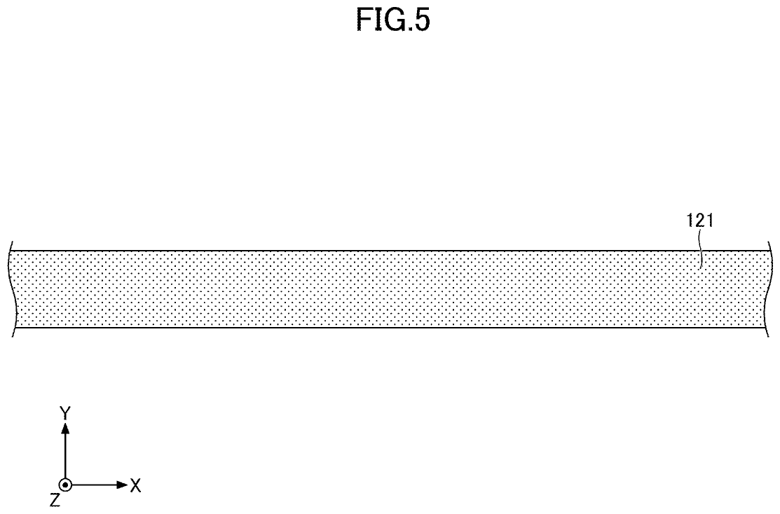

Hereinafter, the method of manufacturing the lead member 1 will be described. FIGS. 4 to 7 are plan views illustrated for the method for manufacturing the lead member 1 according to the first embodiment. These are plan views illustrated for the method of manufacturing the lead member 1.

First, as illustrated in FIG. 4, a metal tape 120 is prepared. The metal tape 120 will later become the metal substrate 20. The metal tape 120 is formed, for example, of aluminum (Al), an aluminum alloy, nickel (Ni), a nickel alloy, copper (Cu), a copper alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy, or the like.

Then, as illustrated in FIG. 5, a surface treatment layer 121 is formed on the surface of the metal tape 120. The surface treatment layer 121 will later become the surface treatment layer 21. When forming the surface treatment layer 121, the surface treating liquid that contains chromium fluoride tetrahydrate (CrF₃·4H₂O) is applied to the surface of the metal tape 120, and is dried at a temperature, for example, of 220° C. or higher. That is, the surface treatment solution that contains trivalent Cr is used. The drying facilitates the crosslinking reaction with Cr. The drying is performed, for example, under an atmosphere in which relative humidity is 75% RH or less.

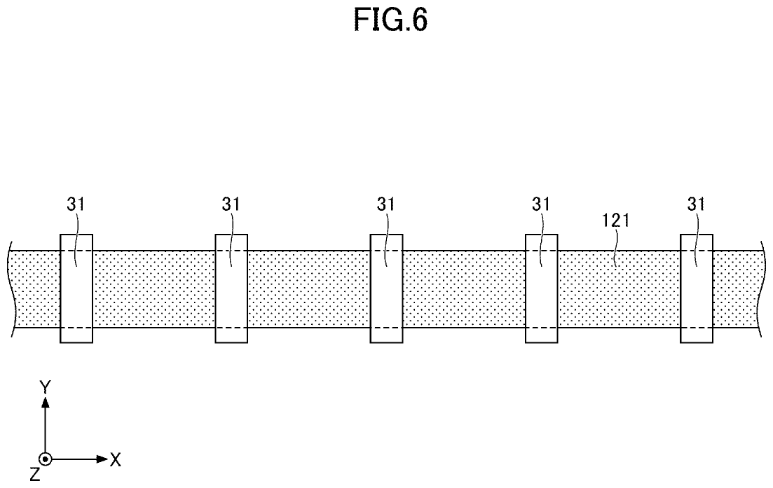

Then, as illustrated in FIG. 6, a plurality of sets of resin films 31 and 32 are prepared, and the resin films 31 and 32 are bonded to each other such that the metal tape 120 on which the surface treatment layer 121 is formed is interposed between the resin films 31 and 32. Then, the metal tape 120 on which the surface treatment layer 121 is formed, and the resin films 31 and 32 are interposed between an upper head and a lower head of a hot press machine, and subsequently, a hot press is performed to heat-seal the resin films 31 and 32 to the metal tape 120 on which the surface treatment layer 121 is formed. This process is performed on the metal tape 120, at fixed intervals. With this approach, a continuous body for the lead member is obtained.

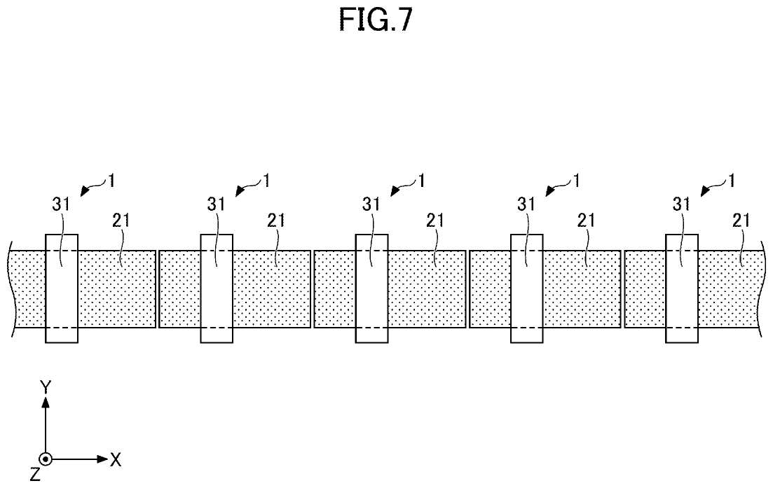

Then, as illustrated in FIG. 7, the continuous body for the lead member is cut between adjacent pairs of the resin films 31 and 32. With this approach, a plurality of lead members 1 are obtained.

In the example of manufacturing method described above, the continuous body for the lead member is cut after heat-sealing the resin films 31 and 32 to the metal tape 120. However, the resin films 31 and 32 may be heat-sealed after dividing, into multiple pieces, the metal tape 120 on which the surface treatment layer 121 is formed.

### Second Embodiment

A second embodiment will be described as follows. The second embodiment relates to the lead member. The second embodiment differs from the first embodiment in a characteristic of the surface treatment layer 21.

In the second embodiment, for the portion of the surface treatment layer 21 exposed from the resin portion 30, a value of a parameter P is 10.0 or less, preferably 7.0 or less, and more preferably 5.0 or less, where the value of the parameter P is obtained by dividing, by a chromium content per unit area, an integrated value of peak intensity within a wave number range of 2750 cm⁻¹ to 3700 cm⁻¹ in a reflection infrared spectrum. An amount of hydroxyl groups of the surface treatment layer 21 is reflected on the value of the parameter P, and if the parameter P exceeds 10.0, sufficient weldability is not be provided. For example, when a plurality of lead members are stacked, and respective portions of lead conductors 10 that are each exposed from the resin portion 30 are welded to each other, misalignment between the lead members may occur.

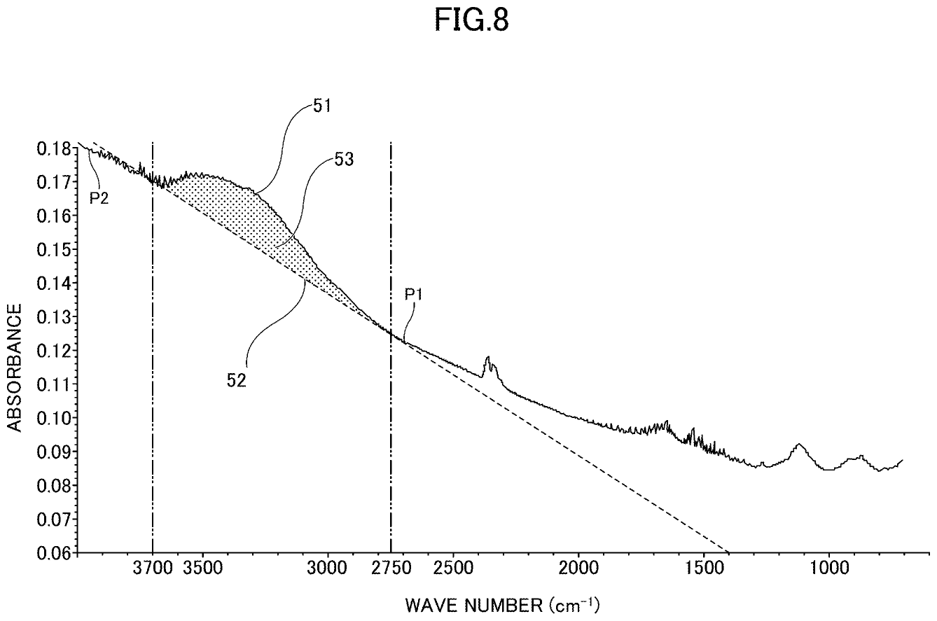

Hereinafter, the parameter P in the present disclosure will be described. The reflection infrared spectrum can be obtained by Fourier transform infrared spectroscopy (FT-IR). FIG. 8 is a diagram illustrating an example of the reflection infrared spectrum. In FIG. 8, the horizontal axis represents the wave number (cm⁻¹), and the vertical axis represents absorbance (dimensionless).

In order to acquire the reflection infrared spectrum, a variable-angle reflector accessory is first attached to an infrared spectrometer, and a reflection infrared spectrum 51 from the surface of a sample is acquired. As the infrared spectrometer, for example, Nicolet8700 manufactured by Thermo Fisher Scientific K.K. can be used. As the variable-angle reflector accessory, for example, the variable-angle reflective accessory (P/N 81030782) manufactured by Thermo Fisher Scientific K.K. can be used. The wave number range is from 4000 cm⁻¹ to 600 cm⁻¹, a wave number resolution is 4 cm⁻¹, the number of accumulations is 32, and an incident angle for a light source is 80°. Triglycine sulfate (TGS) is used in a detector. A gold (Au) plate is used for a background.

For the reflection infrared spectrum 51, a straight line connecting a point P1 of 2700 cm⁻¹ and a point P2 of 3950 cm⁻¹ is defined as a second baseline 52. Thereafter, within the wave number range of greater than or equal to 2750 cm⁻¹ and less than or equal to 3700 cm⁻¹, an area of a region 53 that is surrounded by the reflection infrared spectrum 51 and the second baseline 52 is calculated as an integrated value B of peak intensity. Separately, a Cr content X (μg/cm²) per unit area of the surface of the sample is measured. The Cr content X can be determined by a general analysis method such as inductively coupled plasma optical emission spectrometry (ICP-OES). Then, the parameter P is identified by Equation 2. A value obtained by Equation 2 is rounded off to two decimal places, for example.

(Math. 2)

P=B/X (Equation 2)

Other configurations are adopted as in the first embodiment.

In the lead member according to the second embodiment, because the surface treatment layer 21 contains F, the lead member has good corrosion resistance to the non-aqueous electrolyte solution, particularly the non-aqueous electrolyte solution that contains F. For a portion of the surface treatment layer 21 exposed from the resin portion 30, the value of the parameter P is 10.0 or less, where the value of the parameter P is obtained by dividing, by the chromium content (μg/cm⁻¹) per unit area, an integrated value of peak intensity within a wave number range of 2750 cm⁻¹ to 3700 cm⁻¹ in the reflection infrared spectrum. With this arrangement, excellent weldability is provided. Also, the amount of hydroxyl groups is small, and thus decomposition of the non-aqueous electrolytic solution due to the hydroxyl groups that are contained in the surface treatment layer 21 can be reduced. In addition, if the hydroxyl group and the non-aqueous electrolytic solution react with each other, pin holes are generated, and thus the non-aqueous electrolytic solution comes into contact with the metal substrate 20 so that metal ions might be eluted from the metal substrate 20. However, possibilities for such elution can be reduced.

The lead member according to the second embodiment can be manufactured by the same method as described in the first embodiment.

### Third Embodiment

A third embodiment will be described as follows. The third embodiment relates to the lead member. The third embodiment differs from the first embodiment and second embodiment in the characteristic of the surface treatment layer 21.

In the third embodiment, in an X-ray absorption spectrum for the portion of the surface treatment layer 21 exposed from the resin portion 30, the horizontal axis represents the X-ray energy of 1 eV in one division, and the vertical axis represents the X-ray absorption of 0.1 in one division. Where, in such an X-ray absorption spectrum, a point at which X-ray energy is 6008 eV is defined as a point A, a point at which X-ray energy is 6011 eV is defined as a point B, and a point at which X-ray energy is 6016 eV is defined as a point C. In this case, an angle BAC is 17 degrees or less, and the length of the one division represented on the horizontal axis is equal to the length of the one division represented on the vertical axis. The magnitude of the angle BAC is preferably 12 degrees or less, and more preferably 10 degrees or less. Coordination environments of oxygen (O) and fluorine (F) with respect to chromium (Cr) are reflected on the X-ray absorption spectrum. If the magnitude of the angle BAC exceeds 17 degrees, a coupling between atoms in the surface treatment layer 21 is weak, and thus corrosion resistance is not sufficiently provided. For example, when a given lead member is immersed in a lithium ion battery electrolyte, the lithium ion battery electrolyte may enter the interface between the lead conductor and a given resin film, by using the surface treatment layer 21, and thus peeling of the resin film may occur.

Hereinafter, a method of evaluating the X-ray absorption spectrum will be described. In the present embodiment, as an example, the X-ray absorption spectrum is measured by a conversion electron yield method. The X-ray absorption spectrum may be measured by any other method such as fluoroscopy or a fluorescence yield method. In the X-ray absorption spectrum, the horizontal axis represents X-ray energy (eV), and the vertical axis represents normalized X-ray absorption (arbitrary unit, a.u.).

As a facility for measuring the X-ray absorption spectrum, for example, an analysis device that is installed in a plurality of beam lines (specifically, BL16B2 or BL14B2) of a large synchrotron radiation facility, SPring-8 (Spring Eight), may be used. BL11 or BL16 at SAGA Light Source (SAGA-LS) may also be used. BL5S1 or BL11S2 at Aichi Synchrotron Radiation Center (AichiSR) may be used. Any other facility where the X-ray absorption spectrum can be measured may also be used.

The X-ray absorption spectrum as obtained above is not directly evaluated, and values of the X-ray energy as represented on the horizontal axis are calibrated. In this description, the horizontal axis is calibrated using metal chromium. Specifically, the X-ray absorption spectrum from the metal chromium is measured, and values on the horizontal axis are adjusted such that a peak top point of the X-ray absorption spectrum becomes 6008.2 eV. The top peak point of the metal chromium is close to 6008.2 eV. In contrast, as described above, the point A is set to be the point at which the X-ray energy is 6008 eV. The reason why such a difference in 0.2 eV is set is that the top peak in a case where O and F are coordinated to chromium is slightly small.

The normalized X-ray absorption in the X-ray absorption spectrum as represented on the vertical axis is obtained as follows. For example, for the X-ray absorption spectrum, an arbitrary range of the lowest value, −5900 eV, to the highest value, −5970 eV, is subtracted as a background region, and thus an arbitrary range of from the lowest value, 6050 eV, to the highest value, 6900 eV, is set as a normalization region, where the two points described above derived from the background region are separated from each other by at least 10 eV, and the two points described above derived from the normalization region are separated from each other by at least 20 eV.

For example, commercially available software such as REX2000 manufactured by Rigaku Corporation may be used to obtain the normalized X-ray absorption spectrum in the X-ray absorption spectrum as represented on the vertical axis. Free software specialized for analysis of X-ray absorption near edge structure (XANES) spectra, such as Athena, may be used. By using such analysis software, XANES is used to generate a graph based on the analysis procedure described above, and a shape of the X-ray absorption spectrum can be evaluated from the graph, as described above.

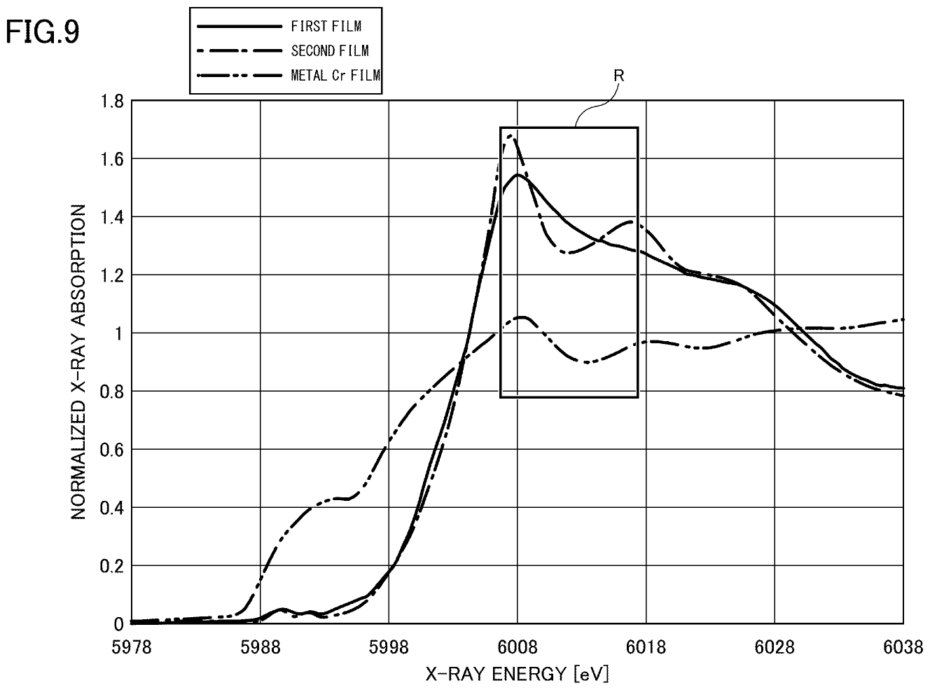

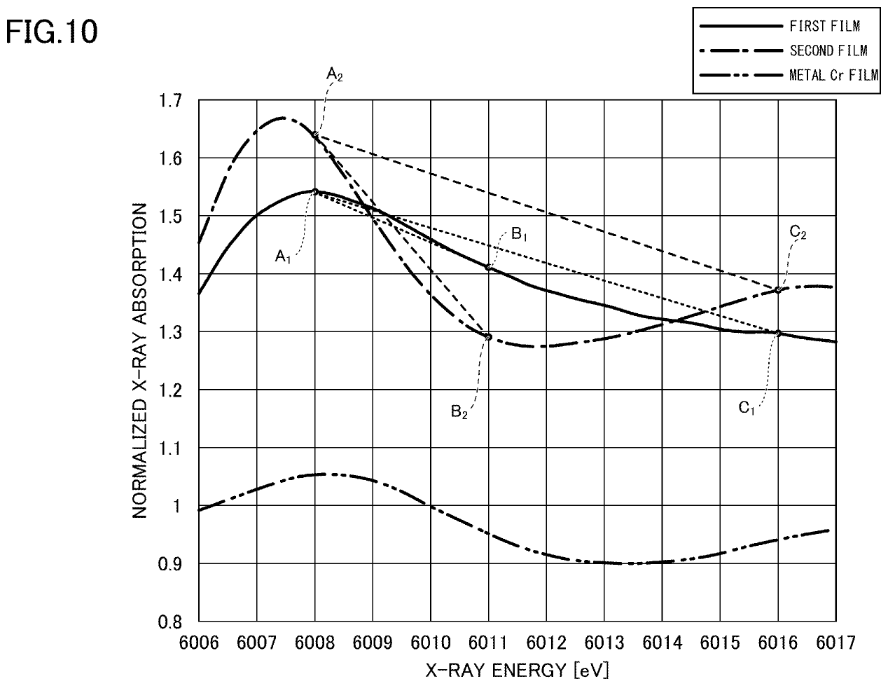

FIGS. 9 and 10 illustrate examples of the X-ray absorption spectrum. FIG. 10 is an enlarged view of a region R in FIG. 9. In FIGS. 9 and 10, the horizontal axis represents X-ray energy (eV), and the vertical axis represents the normalized X-ray absorption (arbitrary unit, a.u.). FIGS. 9 and 10 illustrate the X-ray absorption spectra for a surface treatment layer (first film) for which the magnitude of the above angle BAC is 17 degrees or less; a surface treatment layer (second film) for which the magnitude of the angle BAC is greater than 17 degrees; and a reference metal Cr film. In the first film, the magnitude of an angle B₁A₁C₁ is 4.2 degrees, and in the second film, the magnitude of an angle B₂A₂C₂ is 28.6 degrees. The first film has good corrosion resistance, but the second film does not have sufficient corrosion resistance.

If a measurement point at which the X-ray energy is 6008 eV is not included in the X-ray absorption spectrum, a measurement point at which the X-ray energy is the closest energy to 6008 eV in the range of 6007.5 eV to 6008.5 eV may be set as a point A. If a measurement point at which the X-ray energy is 6011 eV is not included in the X-ray absorption spectrum, a measurement point at which the X-ray energy is the closest energy to 6011 eV in the range of 6010.5 eV to 6011.5 eV may be set as a point B. If a measurement point at which the X-ray energy is 6016 eV is not included in the X-ray absorption spectrum, a measurement point at which the X-ray energy is the closest energy to 6016 eV in the range of 6015.5 eV to 6016.5 eV may be set as a point C.

In the lead member according to the third embodiment, because the surface treatment layer 21 contains F, the lead member has good corrosion resistance to the non-aqueous electrolyte solution, particularly the non-aqueous electrolyte solution that contains a hydrofluoric acid. Further, the magnitude of the angle BAC in the X-ray absorption spectrum is 17 degrees or less. Thus, excellent corrosion resistance is provided.

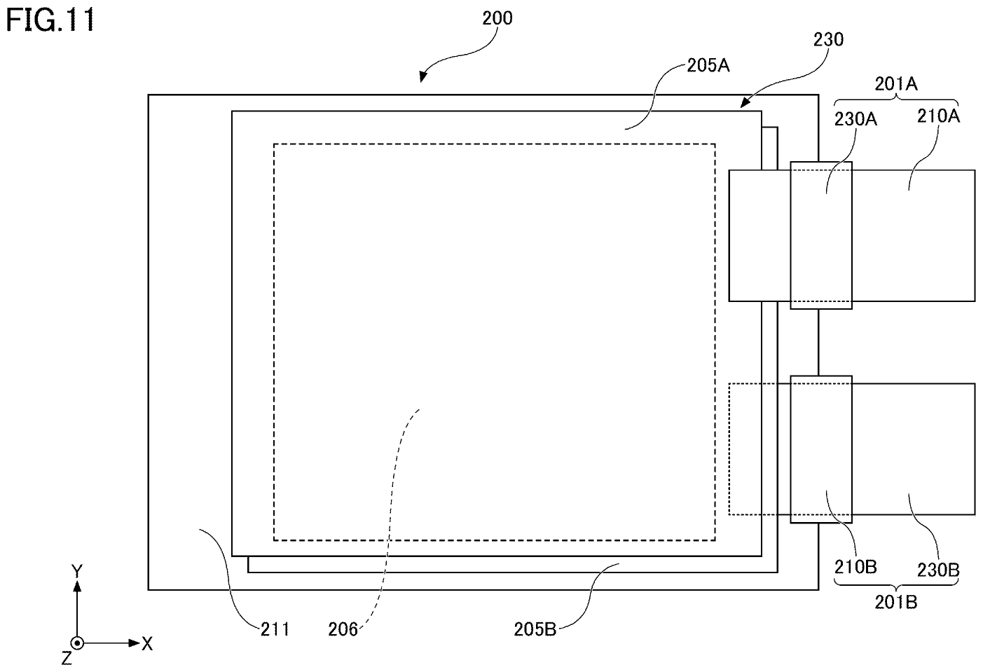

The lead members according to the first to third embodiments can be used for an enclosure-type non-aqueous electrolyte battery. FIG. 11 is a schematic diagram illustrating the enclosure-type non-aqueous electrolyte battery.

As illustrated in FIG. 11, in an interior of a non-aqueous electrolytic battery 200, a positive electrode 205A and a negative electrode 205B overlap with each other such that a separator 206 is interposed between the positive electrode 205A and the negative electrode 205B. A lead conductor 210A in a positive-electrode tab lead 201A is joined to the positive electrode 205A by welding or the like. A lead conductor 210B in a negative-electrode tab lead 201B is joined to the negative electrode 205B by welding or the like. An assembly 230 with the positive electrode 205A, the negative electrode 205B, the separator 206, the positive-electrode tab lead 201A, and the negative-electrode tab lead 201B is accommodated in an enclosure 211 such that respective portions (portions on a side opposite to the positive electrode 205A and the negative electrode 205B) of the positive-electrode tab lead 201A and the negative-electrode tab lead 201B protrude outside from the enclosure 211.

For example, the lead member 1 according to the first embodiment is used as each of the tab leads 201A and 201B. That is, the tab lead 201A includes a lead conductor 210A corresponding to the lead conductor 10, and includes a resin portion 230A corresponding to the resin portion 30. The tab lead 201B includes a lead conductor 210B corresponding to the lead conductor 10, and includes a resin portion 230B corresponding to the resin portion 30.

An electrolyte is injected in the enclosure 211. An opening of the enclosure 211 is heat-sealed such that the enclosure encloses the lead conductors 210A and 210B taken out to the outside, and overlaps the resin portions 230A and 230B of the tab leads 201A and 201B disposed in the opening of the enclosure 211. Ends of the lead conductors 210A and 210B and the resin portions 230A and 230B in the X-direction are disposed outside the enclosure 211.

The non-aqueous electrolyte battery 200 has the above configuration. The lead member according to the second embodiment or the third embodiment may be used as each of the tab leads 201A and 201B.

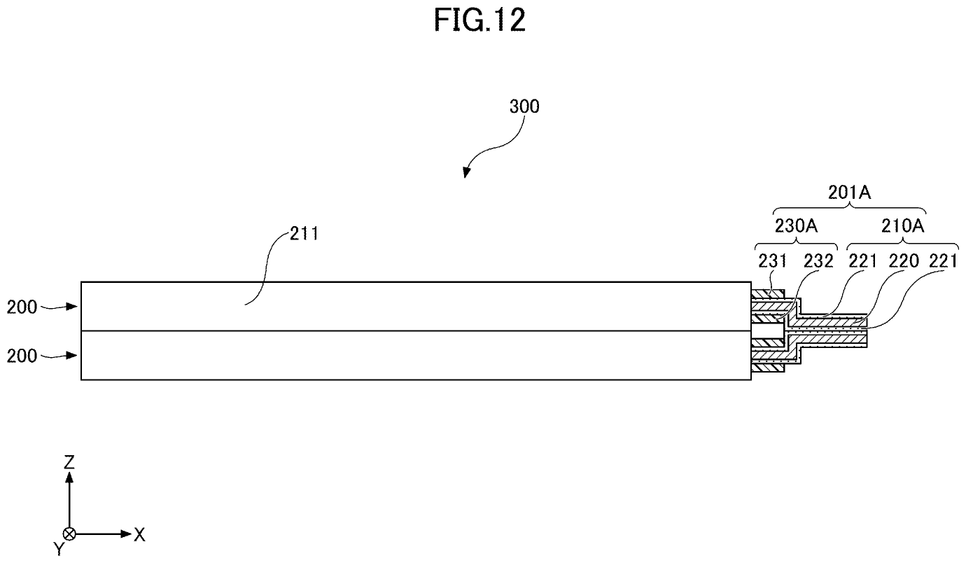

For example, a plurality of the non-aqueous electrolytic batteries 200 may be overlapped to be used by welding lead conductors 210A to each other, and by welding lead conductors 210B to each other, and the lead conductors 210A and the lead conductors 210B are disposed outside the enclosure 211. FIG. 12 is a cross-sectional view of a battery module with the non-aqueous electrolyte batteries.

As illustrated in FIG. 12, a battery module 300 includes, for example, two non-aqueous electrolyte batteries 200. Lead conductors 210A disposed outside the enclosures 211 of the non-aqueous electrolytic batteries 200 are joined, at respective ends of the lead conductors, to each other by welding. Each lead conductor 210A includes a metal substrate 220 corresponding to the metal substrate 20, and includes a surface treatment layer 221 corresponding to the surface treatment layer 21. Each resin portion 230A includes a resin film 231 corresponding to the resin film 31, and includes a resin film 232 corresponding to the resin film 32.

Although not illustrated in FIG. 12, lead conductors 210B disposed outside the enclosures 211 are also joined, at respective ends, to each other by welding. Each lead conductor 210B includes a metal substrate 220 corresponding to the metal substrate 20, and includes a surface treatment layer 221 corresponding to the surface treatment layer 21. Each resin portion 230B includes a resin film 231 corresponding to the resin film 31, and includes a resin film 232 corresponding to the resin film 32.

Each of the lead conductor 210A included in the tab lead 201A, and the lead conductor 210B included in the tab lead 201B corresponds to the lead conductor 10, thereby providing excellent weldability. With this arrangement, welding of lead conductors 210A, and welding of lead conductors 210B are satisfactorily performed with respect to the two non-aqueous electrolytic batteries 200.

A test example will be described below. In the test example, samples used for various lead members were produced. The temperature at which a surface treating liquid was dried was changed between the samples. Other conditions were identical. For each sample, the moisture content A, the parameter P, and the parameter Q were identified. The samples were evaluated for weldability and corrosion resistance. These results are illustrated in Tables 1 to 3 below.

In the evaluation for weldability, two lead members were overlapped and ultrasonically welded to a copper plate, and the presence or absence of slippage between the lead members was checked. In Tables 1 to 3, A indicates that a slippage amount was 0. 5 mm or less, and B indicates that increased slippage occurred with the slippage amount greater than 0. 5 mm.

In the evaluation for corrosion resistance, the lead members were each immersed in a given lithium ion battery electrolyte for 24 hours, and the presence or absence of peeling of a given resin film was checked. In Tables 1 to 3, A indicates that 180° peel adhesion to a given resin film was 10 N/cm or greater, and B indicates that 180° peel adhesion to a given resin film was less than 10 N/cm.

TABLE 1

| | DRYING | MOISTURE | | |
|---|---|---|---|---|
| | TEMPERATURE | CONTENT | WELD- | CORROSION |
| No. | (° C.) | (μg/cm²) | ABILITY | RESISTANCE |
| 1 | 80 | 13.0 | B | B |
| 2 | 100 | 8.1 | B | B |
| 3 | 120 | 7.2 | B | B |
| 4 | 140 | 7.0 | B | B |
| 5 | 170 | 6.2 | B | B |
| 6 | 170 | 5.8 | B | B |
| 7 | 200 | 4.8 | A | A |
| 8 | 230 | 1.7 | A | A |
| 9 | 230 | 0.2 | A | A |
| 10 | 300 | 0.4 | A | A |
| 11 | 300 | 3.6 | A | A |

TABLE 2

| | DRYING | | | |
|---|---|---|---|---|
| | TEMPERATURE | | WELD- | CORROSION |
| No. | (° C.) | PARAMETER P | ABILITY | RESISTANCE |
| 1 | 80 | 18.1 | B | B |
| 2 | 100 | 14.3 | B | B |
| 3 | 120 | 11.6 | B | B |
| 4 | 140 | 12.1 | B | B |
| 5 | 170 | 10.1 | B | B |
| 6 | 170 | 13.5 | B | B |
| 7 | 200 | 9.2 | A | A |
| 8 | 230 | 6.6 | A | A |
| 9 | 230 | 5.8 | A | A |
| 10 | 300 | 5.0 | A | A |
| 11 | 300 | 4.1 | A | A |

TABLE 3

| | DRYING | MAGNITUDE | | |
|---|---|---|---|---|
| | TEMPERATURE | OF ANGLE BAC | WELD- | CORROSION |
| No. | (° C.) | (DEGREES) | ABILITY | RESISTANCE |
| 1 | 80 | 28.6 | B | B |
| 2 | 100 | 27.1 | B | B |
| 3 | 120 | 23.5 | B | B |
| 4 | 140 | 21.0 | B | B |
| 5 | 170 | 18.1 | B | B |
| 6 | 170 | 20.9 | B | B |
| 7 | 200 | 15.7 | A | A |
| 8 | 230 | 11.9 | A | A |
| 9 | 230 | 11.4 | A | A |
| 10 | 300 | 9.8 | A | A |
| 11 | 300 | 7.6 | A | A |

Although the embodiments are described above in detail, these are not limited to specific embodiments. Various modifications and changes can be made within the scope set forth in the claims.

### DESCRIPTION OF SYMBOLS

1, 2 lead member
10 lead conductor
11 first main surface
12 second main surface
13 side surface
20 metal substrate
21 surface treatment layer
30 resin portion
31 resin film
32 resin film
51 reflection infrared spectrum
52 second baseline
53 region
120 metal tape
121 surface treatment layer
200 non-aqueous electrolyte battery
201A positive-electrode tab lead
201B negative-electrode tab lead
205A positive electrode
205B negative electrode
206 separator
210A lead conductor
210B lead conductor
211 enclosure
220 metal substrate
221 surface treatment layer
230 assembly
230A resin portion
230B resin portion
231 resin film
232 resin film
300 battery module

1. A lead member comprising:
a lead conductor having a first main surface and a second main surface opposite to the first main surface; and
a resin portion that covers the first main surface, the second main surface, and two side surfaces that are between both ends of the lead conductor, while exposing the both ends of the lead conductor in a first direction,
wherein the lead conductor includes:
a metal substrate, and
a surface treatment layer formed on at least a portion of a surface of the metal substrate, the surface treatment layer including chromium, oxygen, and fluorine, and
wherein a moisture content of a portion of the surface treatment layer exposed from the resin portion, as measured by coulometric Karl Fischer titration at a vaporization temperature of 220° C., is 5.0 sg/cm² or less.

2. A lead member comprising:
a lead conductor having a first main surface and a second main surface opposite to the first main surface; and
a resin portion that covers the first main surface, the second main surface, and two side surfaces that are between both ends of the lead conductor, while exposing the both ends of the lead conductor in a first direction,
wherein the lead conductor includes:
a metal substrate, and
a surface treatment layer formed on at least a portion of a surface of the metal substrate, the surface treatment layer including chromium, oxygen, and fluorine, and
wherein, for a portion of the surface treatment layer exposed from the resin portion, a value of a parameter that is obtained by dividing, by a chromium content (μg/cm²) per unit area, an integrated value of peak intensity in a wave number range of greater than or equal to 2750 cm⁻¹ and less than or equal to 3700 cm⁻¹ in a reflection infrared spectrum is 10.0 or less.

3. A lead member comprising:
a lead conductor having a first main surface and a second main surface opposite to the first main surface; and
a resin portion that covers the first main surface, the second main surface, and two side surfaces that are between both ends of the lead conductor, while exposing the both ends of the lead conductor in a first direction,
wherein the lead conductor includes:
a metal substrate, and
a surface treatment layer formed on at least a portion of a surface of the metal substrate, the surface treatment layer including chromium, oxygen, and fluorine,
wherein, in an X-ray absorption spectrum for a portion of the surface treatment layer exposed from the resin portion, when one division on a horizontal axis indicates X-ray energy of 1 eV, and one division on a vertical axis indicates X-ray absorption of 0.1, a magnitude of an angle BAC is 17 degrees or less, where, for the X-ray absorption spectrum, a point A is a point at which the X-ray energy is 6008 eV, a point B is a point at which the X-ray energy is 6011 eV, and a point C is a point at which the X-ray energy is 6016 eV, and
wherein a length of the one division on the horizontal axis is equal to a length of the one division on the vertical axis.

4. The lead member according to claim 1, wherein the surface treatment layer is an inorganic layer.

5. The lead member according to claim 1, wherein the surface treatment layer is free of C.

6. The lead member according to claim 1, wherein the surface treatment layer is provided at least between the metal substrate and the resin portion.

7. The lead member according to claim 1, wherein the surface treatment layer is provided on an entirety of the first main surface and the second main surface.

8. The lead member according to claim 1, wherein the metal substrate is formed of aluminum, an aluminum alloy, nickel, a nickel alloy, copper, a copper alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy.

9. The lead member according to claim 1, wherein the resin portion includes polypropylene.

10. The lead member according to claim 2, wherein the surface treatment layer is an inorganic layer.

11. The lead member according to claim 3, wherein the surface treatment layer is an inorganic layer.

12. The lead member according to claim 2, wherein the surface treatment layer is free of C.

13. The lead member according to claim 3, wherein the surface treatment layer is free of C.

14. The lead member according to claim 2, wherein the surface treatment layer is provided at least between the metal substrate and the resin portion.

15. The lead member according to claim 3, wherein the surface treatment layer is provided at least between the metal substrate and the resin portion.

16. The lead member according to claim 2, wherein the surface treatment layer is provided on an entirety of the first main surface and the second main surface.

17. The lead member according to claim 3, wherein the surface treatment layer is provided on an entirety of the first main surface and the second main surface.

18. The lead member according to claim 2, wherein the metal substrate is formed of aluminum, an aluminum alloy, nickel, a nickel alloy, copper, a copper alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy.

19. The lead member according to claim 3, wherein the metal substrate is formed of aluminum, an aluminum alloy, nickel, a nickel alloy, copper, a copper alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy.

20. The lead member according to claim 2, wherein the resin portion includes polypropylene.
